(19) United States
(12) Patent Application Publication
(10) Pub. No.: US 2024/0149781 A1
(43) Pub. Date: May 9, 2024

(54) Digital Vehicle Sign Device And Method

(71) Applicant: Nasteho Sharif, Fort Worth, TX (US)

(72) Inventor: Nasteho Sharif, Fort Worth, TX (US)

(21) Appl. No.: 17/983,537

(22) Filed: Nov. 9, 2022

(51) Int. Cl. B60Q 1/50; B60Q 1/26; B60R 11/02; G09F 9/30; G09F 9/33; H04W 4/40

(52) U.S. Cl. CPC B60Q 1/5035; B60Q 1/268; B60R 11/0235; G09F 9/301; G09F 9/33; H04W 4/40; B60R 2011/0026

(57) ABSTRACT

A digital vehicle sign device and method for emitting words using a mobile device includes a screen being positioned on a rear window of a vehicle. The screen has a peripheral surface and an attachment surface. The peripheral surface has a plurality of strips and each of the strips has a plurality of light emitting diodes. A microprocessor is positioned in a corner of the screen. The microprocessor is in electric communication with the plurality of light emitting diodes of each of the strips of the screen. Additionally, the microprocessor has a transceiver being in wireless communication with a mobile device. The mobile device connects with the microprocessor by a software application. A battery is in electric communication with the screen and provides electric power to the screen.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

(g) BACKGROUND OF THE INVENTION

### (1) FIELD OF THE INVENTION

The disclosure relates to vehicle sign device and more particularly pertains to a new vehicle sign device for emitting words using a mobile device.

### (2) DESCRIPTION OF RELATED ART INCLUDING INFORMATION DISCLOSED UNDER 37 CFR 1.97 AND 1.98

The prior art relates to vehicle sign devices. The prior art includes a variety of vehicle sign devices configured for emitting words to alert other drivers for certain concerns. Furthermore, the prior art includes a variety of vehicle sign devices being digital. Known prior art lacks a vehicle sign device adhering to a rear window of a vehicle and being in wireless communication with a mobile device being configured for emitting words using a plurality of light emitting diodes.

### (H) BRIEF SUMMARY OF THE INVENTION

An embodiment of the disclosure meets the needs presented above by generally comprising a screen being positioned on a rear window of a vehicle. The screen has a peripheral surface and an attachment surface. The peripheral surface has a plurality of strips and each of the strips has a plurality of light emitting diodes. A microprocessor is positioned in a corner of the screen. The microprocessor is in electric communication with the plurality of light emitting diodes of each of the strips of the screen. Additionally, the microprocessor has a transceiver is configured for being in wireless communication with a mobile device. The mobile device is configured for engaging with the microprocessor by a software application. A battery is in electric communication with the screen and is configured for providing electric power to the screen.

Another embodiment of the disclosure includes a method comprising a step of adhering an attachment surface of a screen to a rear window of a vehicle. The driver provides electricity to a battery of the screen by engaging a charging cord with a port of the battery. Subsequently, the driver engages a software application of a mobile device by wireless communication with a transceiver of a microprocessor of the screen. The driver displays a variety of words with a plurality of light emitting diodes of the screen using the software application of the mobile device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a digital vehicle sign device and method according to an embodiment of the disclosure.

FIG. 2 is a rear view of an embodiment of the disclosure.

FIG. 3 is a top isometric view of an embodiment of the disclosure.

FIG. 4 is a block diagram view of an embodiment of the disclosure.

FIG. 5 is an in-use view of an embodiment of the disclosure.

### (J) DETAILED DESCRIPTION OF THE INVENTION

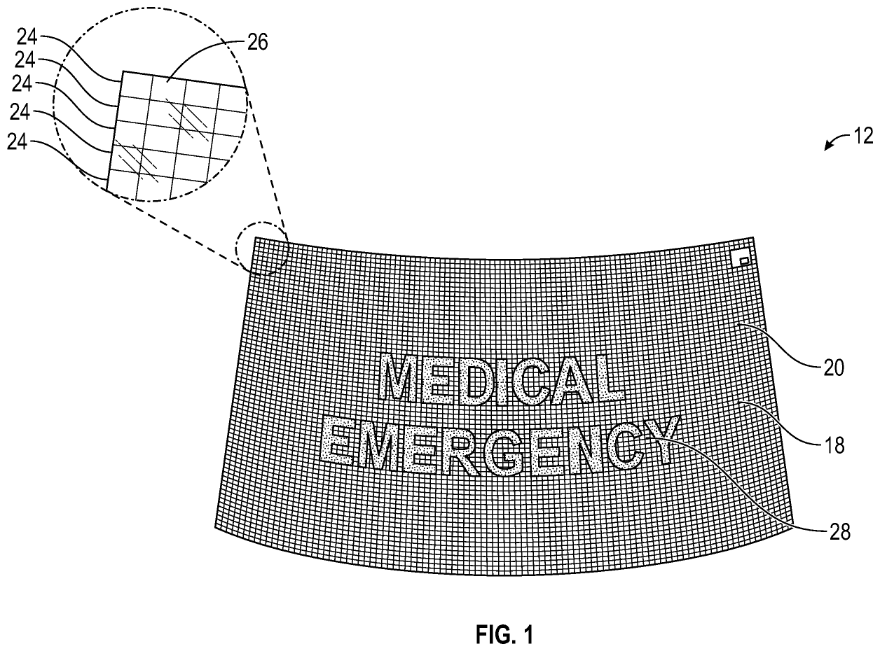

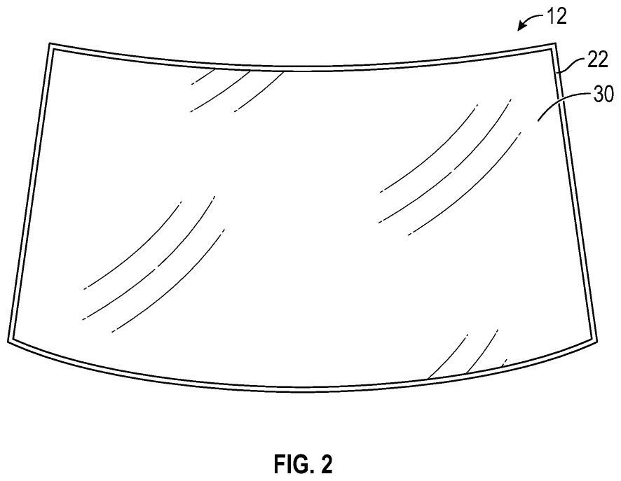

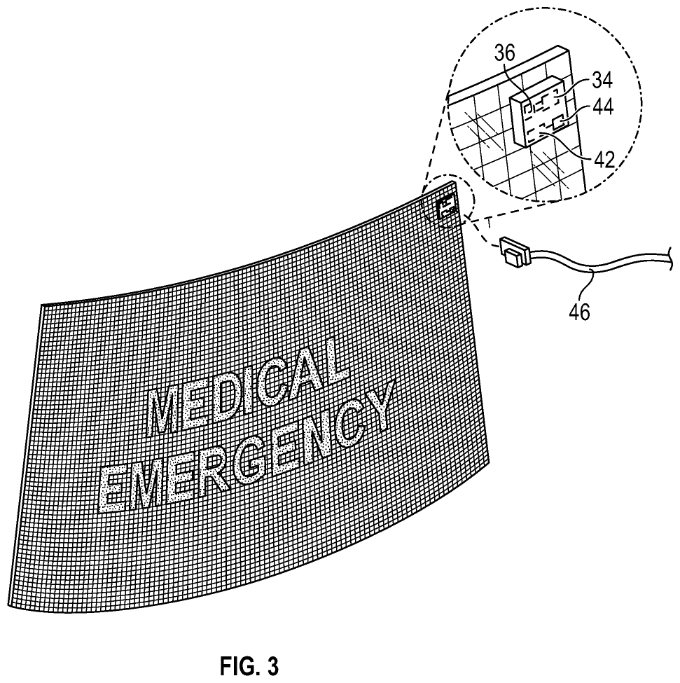

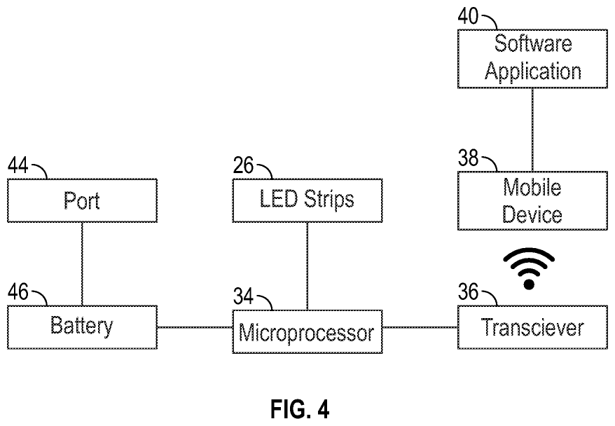

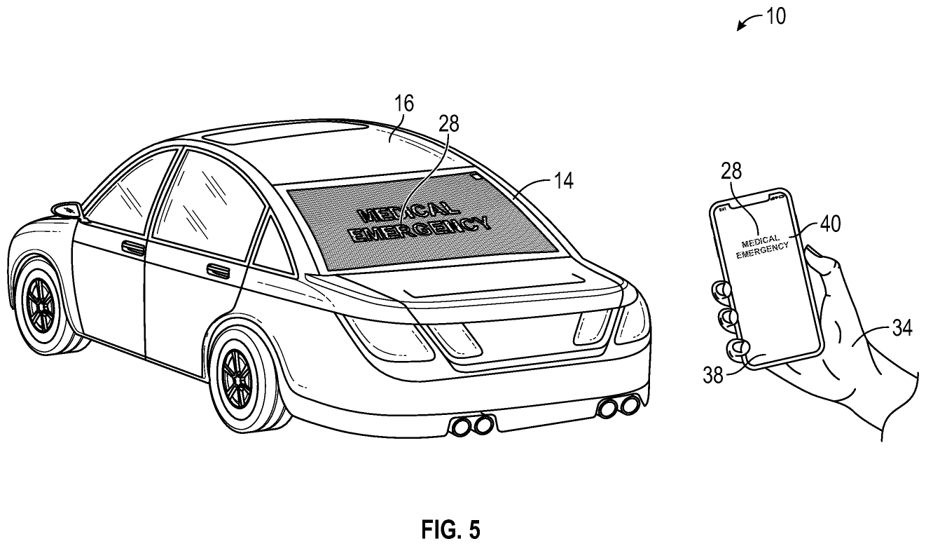

With reference now to the drawings, and in particular to FIGS. 1 through 5 thereof, a new vehicle sign device embodying the principles and concepts of an embodiment of the disclosure and generally designated by the reference numeral 10 will be described.

As best illustrated in FIGS. 1 through 5, the digital vehicle sign device and method 10 generally comprises a screen 12. The screen 12 is positioned on a rear window 14 of a vehicle 16. The screen 12 is a supple material 18 being configured for being flexible and bendable wherein the screen 12 is formed to fit the rear window 14 of the vehicle 16. Furthermore, the screen 12 has a peripheral surface 20 and an attachment surface 22. The peripheral surface 20 has a plurality of strips 24, and each of the strips 24 has a plurality of light emitting diodes 26. The plurality of light emitting diodes 26 of each of the strips 24 is in electric communication with each other, thus the plurality of light emitting diodes 26 work together to create a variety of words 28.

The attachment surface 22 of the screen 12 has an adhesive material 30. The adhesive material 30 of the attachment surface 22 is configured for adhering to the rear window 14 of the vehicle 16 wherein retaining the screen 12 in a fixed position upon the rear window 14. The screen 12 is configured for being transparent from the attachment surface 22 to the peripheral surface 20 wherein a driver 32 of the vehicle 16 can see through the rear window 14. The screen 12 allows the driver 32 to be able to see through the rear window 14 thus reducing a danger of creating a blind spot for the driver 32.

A microprocessor 34 is positioned in a corner of the screen 12. The microprocessor 34 is a central processing unit configured for rendering data and performing operations of the screen 12. The microprocessor 34 is in electric communication with the plurality of light emitting diodes 26 of each of the strips 24 of the screen 12 thus the microprocessor 34 controls the variety of words 28 displayed on the screen 12. The microprocessor 34 has a transceiver 36 being configured for being in wireless communication with a mobile device 38. The mobile device 38 is configured for engaging with the microprocessor 34 by a software application 40. The software application 40 allows the driver 32 to enter the variety of words 40 to be displayed on the screen 12.

A battery 42 is in electric communication with the screen 12, thus the battery 42 is configured for providing electric power to the screen 12. The battery 42 is rechargeable and has a port 44. The port 44 is a universal serial bus port being configured for engaging with a charging cord 46 wherein receiving electricity for the battery 42. The battery 42 receives electricity from the charging cord 46 prior to providing electric power to the screen 12.

In use, the driver 32 fastens the attachment surface 22 of the screen 12 to the rear window 14 of the vehicle 16 using the adhesive material 30 of the attachment surface 22. The driver 32 provides electricity to the battery 42 of the screen 12 by engaging the charging cord 46 with the port 44 of the battery 42. Subsequently, the driver 32 engages the software application 40 of the mobile device 38 by wireless communication with the transceiver 36 of the microprocessor 34 of the screen 12. The driver 32 displays the variety of words 40 with the plurality of light emitting diodes 26 of the screen 12 using the software application 40 of the mobile device 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A digital vehicle sign device configured for emitting words on a windshield of a vehicle, the digital vehicle sign device comprising:
a screen being positioned on a rear window of a vehicle, the screen having a peripheral surface and an attachment surface, the peripheral surface having a plurality of strips, each of the strips having a plurality of light emitting diodes;
a microprocessor being positioned in a corner of the screen, the microprocessor being in electric communication with the plurality of light emitting diodes of each of the strips of the screen, the microprocessor having a transceiver, the transceiver being configured for being in wireless communication with a mobile device, the mobile device being configured for engaging with the microprocessor by a software application; and
a battery being in electric communication with the screen, the battery being configured for providing electric power to the screen.

2. The digital vehicle sign device of claim 1, further comprising the screen being a supple material, the supple material being configured for being flexible and bendable wherein the screen being formed to fit the rear window of the vehicle.

3. The digital vehicle sign device of claim 2, further comprising the plurality of light emitting diodes of each of the strips being in electric communication with each other.

4. The digital vehicle sign device of claim 3, further comprising the attachment surface of the screen having an adhesive material, the adhesive material of the attachment surface being configured for adhering to the rear window of the vehicle wherein retaining the screen in a fixed position upon the rear window.

5. The digital vehicle sign device of claim 4, further comprising the screen being configured for being transparent from the attachment surface to the peripheral surface wherein a driver of the vehicle can see through the rear window.

6. The digital vehicle sign device of claim 1, further the microprocessor being a central processing unit configured for rendering data and performing operations of the screen.

7. The digital vehicle sign device of claim 1, further comprising the battery being rechargeable, the battery having a port, the port being a universal serial bus port, the port being configured for engaging with a charging cord wherein receiving electricity for the battery.

8. A digital vehicle sign device configured for emitting words on a windshield of a vehicle, the digital vehicle sign device comprising:
a screen being positioned on a rear window of a vehicle, the screen being a supple material, the supple material being configured for being flexible and bendable wherein the screen being formed to fit the rear window of the vehicle, the screen having a peripheral surface and an attachment surface, the peripheral surface having a plurality of strips, each of the strips having a plurality of light emitting diodes, the plurality of light emitting diodes of each of the strips being in electric communication with each other, the attachment surface of the screen having an adhesive material, the adhesive material of the attachment surface being configured for adhering to the rear window of the vehicle wherein retaining the screen in a fixed position upon the rear window, the screen being configured for being transparent from the attachment surface to the peripheral surface wherein a driver of the vehicle can see through the rear window;
a microprocessor being positioned in a corner of the screen, the microprocessor being a central processing unit configured for rendering data and performing operations of the screen, the microprocessor being in electric communication with the plurality of light emitting diodes of each of the strips of the screen, the microprocessor having a transceiver, the transceiver being configured for being in wireless communication with a mobile device, the mobile device being configured for engaging with the microprocessor by a software application; and
a battery being in electric communication with the screen, the battery being configured for providing electric power to the screen, the battery being rechargeable, the battery having a port, the port being a universal serial bus port, the port being configured for engaging with a charging cord wherein receiving electricity for the battery.

9. A method for emitting words on a digital vehicle sign, the method comprising a step of:
adhering an attachment surface of a screen to a rear window of a vehicle;
providing electricity to a battery of the screen by engaging a charging cord with a port of the battery;
engaging a software application of a mobile device by wireless communication with a transceiver of a microprocessor of the screen; and
displaying a variety of words with a plurality of light emitting diodes of the screen using the software application of the mobile device.
